(19) United States
(12) Patent Application Publication
(10) Pub. No.: US 2010/0023924 A1
(43) Pub. Date: Jan. 28, 2010

(54) NON-CONSTANT DATA ENCODING FOR TABLE-DRIVEN SYSTEMS

(75) Inventors: Henricus Johannes Maria Meijer, Mercer Island, WA (US); John Wesley Dyer, Monroe, WA (US); Thomas Meschter, Renton, WA (US); Cyrus Najmabadi, New York, NY (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/178,143

(22) Filed: Jul. 23, 2008

(51) Int. Cl. G06F 9/44

(52) U.S. Cl. 717/106

(57) ABSTRACT

Parse tables or like representations are augmented with extension points to enable call out to arbitrary code. Such parse tables can be automatically generated from a specification including fixed information along with information about extensibility points provided. The extensibility points enable incorporation of dynamic data into a fixed parse table. In one instance, this allows a parser to determine if a character is acceptable at the time of execution rather than when the parse table was defined.

### BACKGROUND

A compiler conventionally produces code for a specific target from source code. For example, some compilers transform source code into native code for execution by a specific machine. Other compilers generate intermediate code from source code, where this intermediate code is subsequently interpreted dynamically at runtime or compiled just in time (JIT) to facilitate execution across computer platforms, for instance. Further yet, some compilers are utilized by integrated development environments (IDEs) to perform background compilation to aid programmers by identifying actual or potential issues, among other things.

In general, compilers, perform syntactic and semantic program analysis. Syntactic analysis involves verification of program syntax. In particular, a program or stream of characters is lexically analyzed to recognize tokens such as keywords, operators, and identifiers, among others. Often, these tokens are employed to generate a parse tree as a function of a programming language grammar. A parse tree is made up of several nodes and branches where interior nodes correspond to non-terminals of the grammar and leaves correspond to terminals. The parse tree or some other representation is subsequently employed to perform semantic analysis, which concerns determining and analyzing the meaning of a program.

Syntactic analysis or tree generation is performed by a parser or parse system. Parsers enable programs to either recognize or transcribe patterns matching formal grammars. A parser can be handwritten or automatically generated by feeding a formal specification of a language grammar into a parser generator, which in turn produces necessary code.

Conventionally, automatically generated parsers encode parse states within a table. Tables are used in a wide variety of software applications to encode data necessary to drive an application toward a goal. When the data is small and completely known at development time, it is easy to encode the data into an efficient tabular form for use by an application.

A parse table is employed to drive a parse with respect to an input stream toward its goal. The table for a regular grammar matcher is typically small with only around one hundred columns (one per ASCII character), and a similar number of rows. However, parsers of modern languages are encouraged to support Unicode characters an industry standard. Unicode with over one million potential characters is not well suited for a table-driven approach, as it would force a table to be many megabytes rather than kilobytes in size. While certain techniques such as range encoding and compression attempt to alleviate the problem, they fail to address the dynamism associated with Unicode. What might not be considered a letter today could be considered a letter a year from now. Conventional range encoding techniques require a table to include only static data. As a work around, parsing systems are generally handwritten to encode data otherwise captured in a table.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to encoding of non-constant data for table-driven systems such as parsers. More specifically, in addition to conventional fixed information, a parse table or function can include an extension point that calls external logic. A parser generator can produce this mapping automatically as a function of a lexical specification as well as code that can employ the mapping to parse, scan, lex, and/or tokenize input data. In execution, arbitrary external code can be invoked to process data in various ways. Among other things, this enables introduction of dynamism into a fixed representation. For example, a character can be evaluated as acceptable or unacceptable as a function of rules at the time of parser execution rather than definition. As a result of this increased flexibility, developers can now employ automatic parser generation systems that produce more efficient and high quality parsers than those that are handwritten.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a parser generation system in accordance with an aspect of the disclosure.

FIG. 2 is a block diagram of a representative lexical specification according to a disclosed aspect.

FIG. 3 is a block diagram of a representative extensible map in accordance with an aspect of the disclosure.

FIG. 4 is a block diagram of a compression system in accordance with a disclosed aspect.

FIG. 5 is a flow chart diagram of a method of parser generation in accordance with a disclosed aspect.

FIG. 6 is a flow chart diagram of a method of lexical specification in accordance with an aspect of the disclosed subject matter.

FIG. 7 is a flow chart diagram of an encoding method including one or more extension points in accordance with an aspect of the disclosure.

FIG. 8 is a flow chart diagram of a method of parsing in accordance with an aspect of the disclosure.

FIG. 9 is a schematic block diagram illustrating a suitable operating environment for aspects of the subject disclosure.

FIG. 10 is a schematic block diagram of a sample-computing environment.

### DETAILED DESCRIPTION

Systems and methods pertaining encoding of non-constant data are described in detail hereinafter. The popularity of dynamism with respect to programming has led to a trend away from static mechanisms such as tables and automatic parser generation, which employ these mechanisms. Rather, developers prefer to handwrite code otherwise captured by a table. However, this is error prone, complex, and non-adaptable. In accordance with an aspect the claimed subject matter, static encoding can be provided for conventional fixed data with extensibility for non-constant or dynamic data. A parsing system can then be auto-generated while still meeting obligations of its specification to support dynamism such as that associated with Unicode support. This allows for a higher quality implementation that can be more efficient than handwritten systems.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

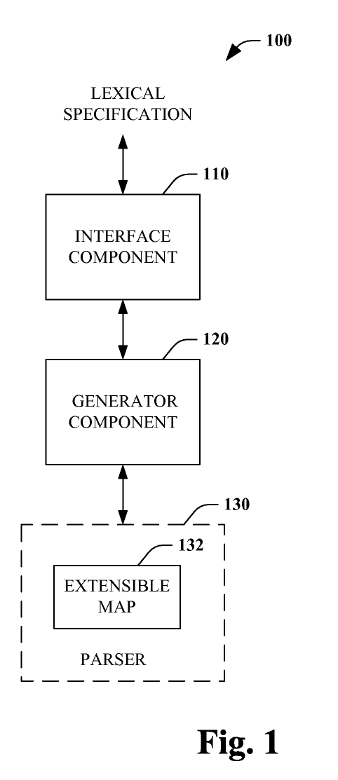

Referring initially to FIG. 1, a parser generation system 100 is illustrated in accordance with an aspect of the claimed subject matter. The system 100 provides a mechanism for automatic generation of a parser and/or portions thereof such as a scanner or lexer. Moreover, the system 100 enables generation of an extensible encoding to address dynamic issues. As depicted, the parser generation system 100 includes an interface component 110 and a generator component 120.

The interface component 110 receives, retrieves or otherwise obtains or acquires a lexical specification. The lexical specification provides a formal description of a set of terminal symbols or tokens recognized by a grammar to aid code scanning, lexing, or tokenizing. In other words, the specification aids lexical analysis or transformation of a sequence of characters into a sequence of tokens. As will be describe further infra, the lexical specification can also include extension or extensibility points.

The generator component 120 receives or retrieves the specification acquired by the interface component 110. Subsequently or concurrently, the generator component 120 can automatically construct a parser 130 (also a component as defined herein) (including a lexer) including an extensible map 132. The auto-generated parser 130 is a mechanism for recognizing valid strings and/or constructing a parse tree. The parser 130 can be driven by the map 132. In other words, the parser can employ the map 132 to govern parsing operations. The map 132 can identify state transformations as a function of current state and an input character, for example. Accordingly, the parser 130 can utilize the map to look up transition states. According to one aspect, the map 132 can be embodied in many forms including but not limited to a function and a table.

Moreover, the map 132 is extensible. It provides a mechanism to enable calls out to or invocation of any arbitrary logic, code, or the like. Rather than specifying a fixed transition state for a current state and input, the map 132 can include a direct or indirect reference to external logic to facilitate identification of the transition state, for example, among other things. In this manner, dynamism is incorporated into an otherwise conventionally fixed mapping. Amongst other things, such dynamism can provide support for a standard yet changing character representation such as Unicode as well as swapping scanners to deal with embedded languages.

Moreover, it is to be appreciated that the added flexibility provided by extensible encoding should act to stymie a trend toward handwritten parsers, especially industrial compilers. As previously mentioned, developers have preferred handwritten parses at least because conventional parser generators lacked adequate support for dynamic issues including but not limited to Unicode support. However, handwritten parsers are often error prone and complex as well as non-adaptable. By contrast, parser generators generally afford a higher quality and more efficient parser than handwritten implementations.

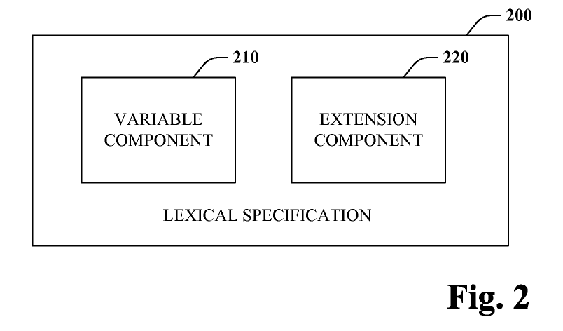

FIG. 2 depicts a representative lexical specification 200 in accordance with an aspect of the claimed subject matter. The specification 200 provides a formal representation of a grammar that defines both programmatic structure of a language and semantic rules inherent in those structures to enable lexical analysis. In addition to conventional specification components, the specification 200 includes a variable component 210. The variable component 210 corresponds to a defined and utilized variable to aid specification. Conventional specification requires inlining of most everything. Here, variables facilitate specification of large and/or complex languages as well as smaller and/or less complex languages. Furthermore, the specification 200 includes an extension component 220 that corresponds to specification of an extension or extensibility point for identification of arbitrary code. In one embodiment, a special delimiter(s) can be employed to escape the current specification and identify or otherwise call out the arbitrary code. For example, a function name can be identified within a set of curly brackets.

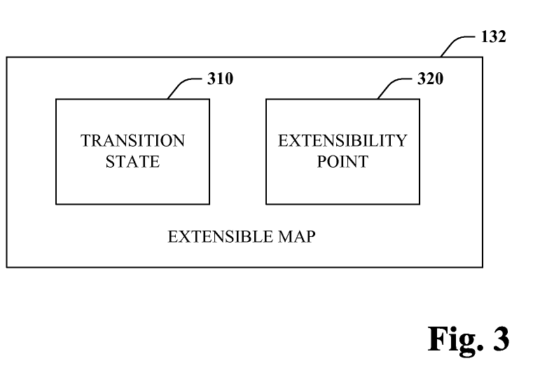

FIG. 3 illustrates a representative extensible map 132 according to an aspect of the claimed subject matter. The extensible map 132 is employed by a parser to determine actions upon receipt of specific input. The extensible map 132 can comprise at least two components, namely transition state component 310 and extensibility point component 320. The transition state component 310 identifies a transition states as a function of a current state and input. In accordance with one embodiment, the transition states can be specified at the intersection of columns and rows denoting state and input, respectively, in a tabular form. The extensibility point component 320 identifies a position in which arbitrary logic or code is to be invoked. In the tabular embodiment, rather than identify a particular transition state at the intersection, an extensibility point is designated. By way of example, the extensibility point can be designated by a character of a reserved character range that corresponds to particular code. Alternatively, the extensibility point can refer to an index from which code can be identified.

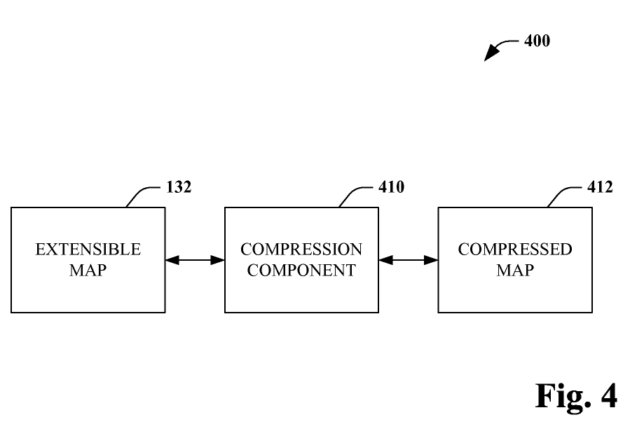

FIG. 4 is a block diagram of a compression system 400 in accordance with an aspect of the claimed subject matter. The system 400 includes a compression component 410 that receives, retrieves, or otherwise acquires an extensible map 132, as previously described. In brief, the map can include fixed data to identify transition states as a function of current state and input as well as one or more extensibility points that enable invocation of arbitrary code at runtime. The component 410 can transform the extensible map 132 into a compressed map 420. In particular, compression can modify the map 132 to reduce size and improve efficiency. It is to be noted that a variety of compression techniques known in the art can be modified to facilitate extensible map compression. However, technique characteristics need to be altered to in light of the additional possibility of extensibility points in particular ranges, for example. Furthermore, compression would be different for the map 132 embodied as a function or table. This corresponds to code optimization versus data optimization.

What follows are specific examples to illustrate aspects of the claimed subject matter. It is to be appreciated that the claimed subject matter is not intended to be limited by these examples. Rather, the sole purpose is to aid clarity and understanding of aspects of the claimed subject matter by way of example. The first example pertains to supporting dynamic character standards.

A programming language specification is generally provided with a specification that defines both the grammatical structure of the language as well as the semantic rules inherent in those structures. For example, a specification may define the grammar for an identifier as follows:

$AsciiLetter=<[a−z]>

Identifier=<${AsciiLetter}+>

In the above snippet, an “AsciiLetter” is declared to be any letter between “a” and “z”. The “Identifer” is then defined as one or more of those letters. Note also that “AsciiLetter” is defined as a variable and utilized in the declaration of “Identifier” rather than inlining the range. Although this is a trivial example since the range is so simple and small, benefits are increase with language size and complexity. Conventional encoding techniques would produce a table such as:

TABLE 1

| | | | | | | | | | | | | | | | | |
|---|---|---|---|---|---|---|---|---|---|---|---|---|---|---|---|---|
| a | b | c | d | e | f | g | h | . | . | . | u | v | w | x | y | z |

State1
State2
. . .
StateN

Contents of the table have been eliminated for clarity, but dictate what new state to move to based on a current state and current character the parser is examining.

Attempting the above encoding with a standard such as Unicode would be untenable, as it would require too much memory to encode millions of necessary columns—one per Unicode character. Range compression techniques are also unsuitable for Unicode, because they encode static range data and Unicode changes over time.

However, conventional systems can be augmented with extensibility points to allow the system to call out to any arbitrary logic to determine a transition state. For example, in a programming language that supports Unicode identifies, a grammar might be specified as follows:

$AsciiRange=<[\u0000−\u007f]>

$NonAsciiRange=<[̂${AsciiRange}]>

$AsciiLetters=<[a−z]>

AsciiIdentifier=<${AsciiLetters}+>

UnicodeIdentifier=<${NonAsciiRange}+>{ScanUnicodeToken}

What this is say is that (1) There is a range of characters called “AsciiRange”; (2) Anything not within that range is called “NonAsciiRange”; (3) “a” through “z” are “AsciiLetters”; (4) If there is one or more “AsciiLetters” that is an “Identifer”; and (5) If there are one or more “NonAsciiRange” characters, a “ScanUnicodeToken” function is called. The last line is significant as this is how dynamic data is incorporated into a fixed table. “ScanUnicodeToken” will all the system to call out to arbitrary code to deal with determining if a character should be allowed based on the rules of the word at the time the program runs, not when it was defined.

Note that “AsciiIdentifer” allows the system to match a common case efficiently where the identifier does not include Unicode. This means that compared with conventional table driven systems, this system employs no overhead. In other words, payment need only be provided for the new functionality as utilized.

Encoding of this data into the table can be performed in a straightforward manner. For instance, a range is defined for all elements not explicitly matched by the fixed data. When non-matched data is encountered, the range is examined to determine if it provides a viable strategy for handling the data. In this parser example, if a viable matching strategy is found, it is passed both the parser state and incoming text stream and is allowed to make a decision on what action to take.

The disclosed encoding techniques can also be employed generally to swap scanners or lexers. In the above Unicode example, the current scanner did not know how to handle this type of character representation. A different scanning mechanism “ScanUnicodeToken” was invoked briefly to handle this issue before passing control back to the original scanner. Similarly, such techniques can be employed with respect to embedded languages, among other things.

In particular, a specification can include multiple lexical specifications corresponding to a host and one or more guest languages. By way of example, consider Visual Basic (VB) with support for XML (eXtensible Markup Language) literals. At a certain point, potentially delineated by a special token, there is a language transition—VB to XML or XML to VB. Upon reading certain tokens, a scanner can be replaced with a new one. Where you have several different lexical specifications, each one is constant but which one is active is variable. Tables can be switched out for instance. By way of example, consider a scanner that is consuming VB characters and then it starts to read or detects the beginning of an XML literal. At this point, a call can be made to refer to an XML literal parse table and a switch made back to a VB table upon completion of XML literal scanning.

Table replacement can be implemented utilizing an additional scanner or lexer state forming a type of hypergraph. If a table corresponds to a function that takes a current state and a lookahead and produces new state, an additional argument can be added that takes the current table of the current scanner state. More specifically, a normal scanner can be defined as follows: “F::(state, lookahead)−>state”. That function can then be utilized together with state and a lookahead to produce another function and a state as follows: “G::(F, state, lookahead)−>(F, state)”.

Various other scenarios can benefit from the disclosed encoding techniques. For example, such mechanisms can be employed to enable call-out to usually handwritten disambiguation routines. Further, the techniques can be used with respect to error correction to provide extensible and safe external error resolution on top of a table-driven parse system.

The aforementioned systems, architectures, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the external code called out from an extension point can include such mechanisms to perform various inferences, for instance. Further, the parser can utilize such techniques to infer the presence of an embedded language. As well, the compression component can employ similar mechanism to optimize table size and efficiency.

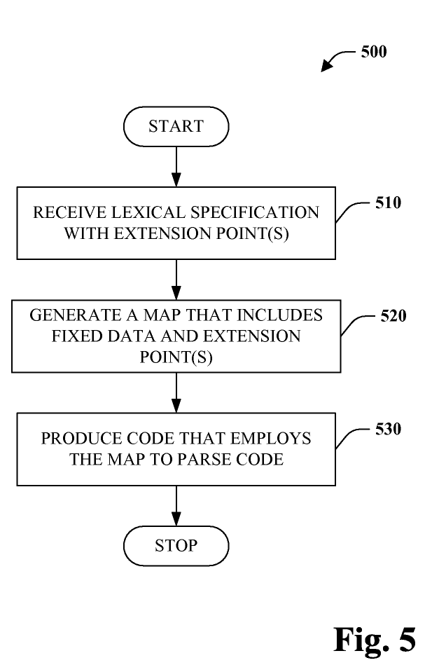

In view of the exemplary systems described supra, methodologies that may be implemented in accordance with the disclosed subject matter will be better appreciated with reference to the flow charts of FIGS. 5-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring to FIG. 5, a parser generation method 500 is illustrated in accordance with an aspect of the claimed subject matter. At reference numeral 510, a lexical specification that includes one or more extension points is received, retrieved or otherwise obtained or acquired. The specification defines both the grammatical structure of a language as well as the semantic rules inherent in those structures. Further, it includes at least one point that specifies invocation of external logic. At reference 520, a map or mapping is generated that includes fixed data and one or more extension points. In one instance, the map can identify a new state as a function of a current state and input and/or lookahead. Further, the map can specify points that reference external code for execution. At numeral 530, code is produced that employs the map to parse code. It is to be noted that both generation of the map and production of code that utilizes the map can be automatic. This provides a higher quality parser implementation that can be more efficient than existing handwritten solutions.

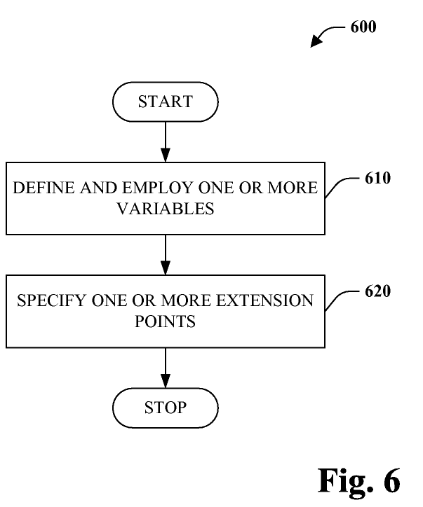

FIG. 6 is a flow chart diagram depicting a method of lexical specification in accordance with an aspect of the claims. A specification defines a formal description of a grammar to aid code scanning, lexing, or tokenizing. It includes both grammatical structure and semantic rules associated with the structure. At reference numeral 610, the one of more variables are defined and employed. Variables can be utilized to aid specification of large and/or complex languages. Rather then requiring inlining of everything, a variable can be defined and reused at multiple points in the specification. At numeral 620, one or more extension points can be specified. These points make reference to invocation of an arbitrary logic or code embodying such logic. This can be accomplished by utilize a set of one or more tokens to identify the extensibility point and referenced code. For example, the squiggly brackets (“{” and “}”) can be utilized to designated an escape from current code and invocation of that designated within the brackets.

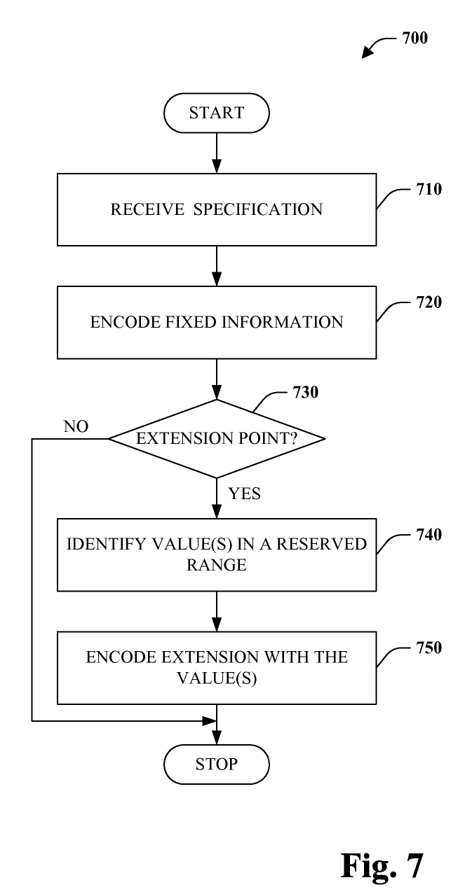

Turning attention to FIG. 7, an encoding method 700 is illustrated in accordance with an aspect of the claimed subject matter. At reference 710, a specification is received. The specification identifies grammatical structure as well as semantics associated with the structure. Furthermore, the specification can also potentially include one or more extension/extensibility points, which designate invocation of external logic. At numeral 720, fixed information is encoded. Such information can include a mapping between current state and input and a new state. The actual encoding can be in the form of a function or a table, amongst others. At reference 730, a determination is made as to whether any extension or extensibility points are present in the specification. If no, the method terminates. If yes, the method continues at 740 where one or more values in a reserved range are identified. The extension is then encoded with one or more identified values at 750. In other words, the identified reserved value can indicate no only that there is call out to external logic but the particular call out. Furthermore, it should be appreciated that the identified value can reference an index from which the extension point can be determined.

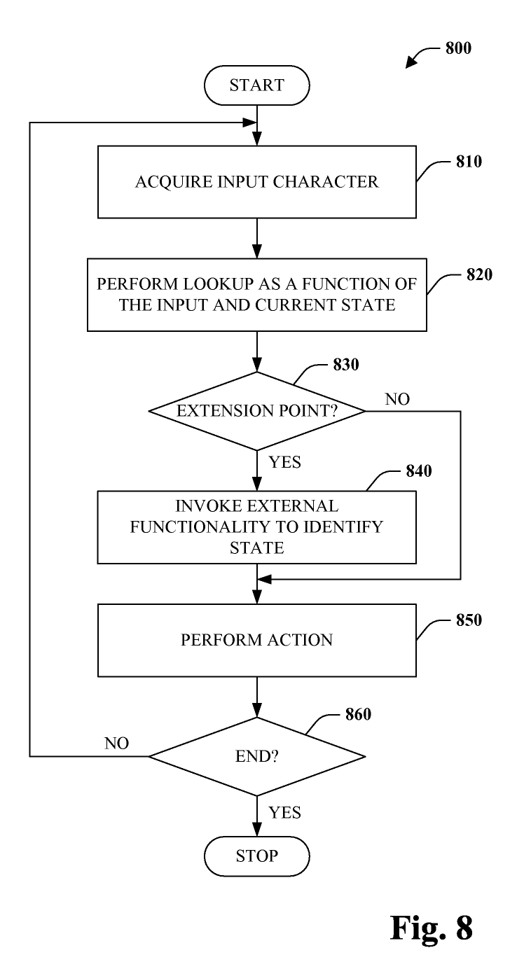

FIG. 8 is a flow chart diagram depicting a parsing method 800 in accordance with an aspect of the claimed subject matter. At reference numeral 810, an input character can be acquired from a set of characters to be parsed. Further, a lookahead may be acquired to facilitate proper identification of the acquired character. At numeral 820, a looked up is performed as a function of the input and current state. For example, a table lookup can be executed in which input and state comprise opposite axes and the lookup value resides at the intersection. At reference 830, it is determined whether the lookup revealed an extension point rather than a more common state. If yes, external functionality associated with the extension is executed to facilitate state identification at numeral 840 and the method proceeds at 850. Alternatively, if an extension point is not found as part of the lookup, then the method simply continues at 850, where any action associated with the new state is performed. At reference numeral 860, a determination is made concerning whether the end of set of characters to be parsed as been detected. If yes, the method terminates. If no, the method continues at 810 where another input character is acquired and the method continues to loop until the end.

The term “parser” or various forms thereof (e.g., parse, parsed, parsing . . . ) is intended to encompass both syntactic and lexical analysis, unless otherwise explicitly noted. Accordingly, a parser can include a lexer, scanner, tokenizer, or any other component that performs syntactic or lexical analysis. By way of example, a lexer can be viewed as a simple kind of parser.

The words “extension point” and “extensibility point” are utilized interchangeably throughout this specification. Their meanings are intended to be the same yet it is to be appreciated that the particular meaning can be context dependent. For example, an “extension point” or “extensibility point” can refer to a portion of a specification that calls for external code or a particular cell in a table identifying external code.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated that a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject innovation.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

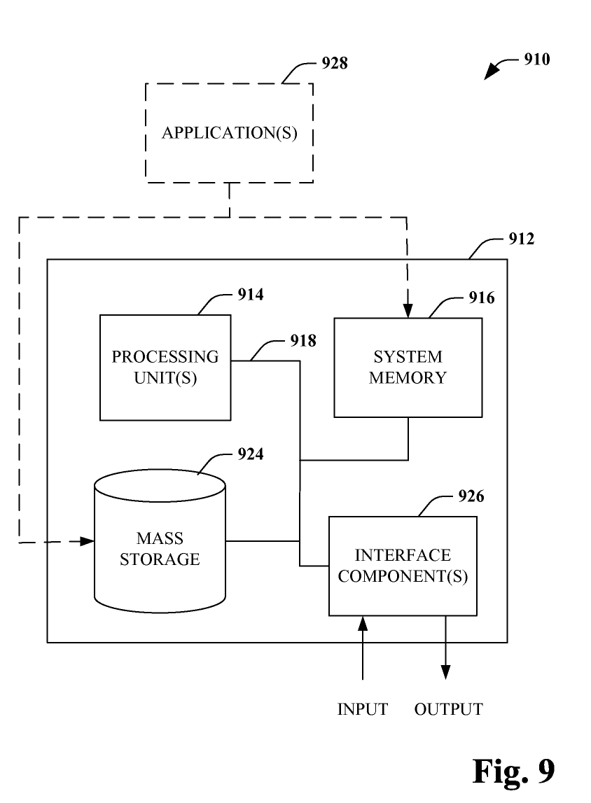

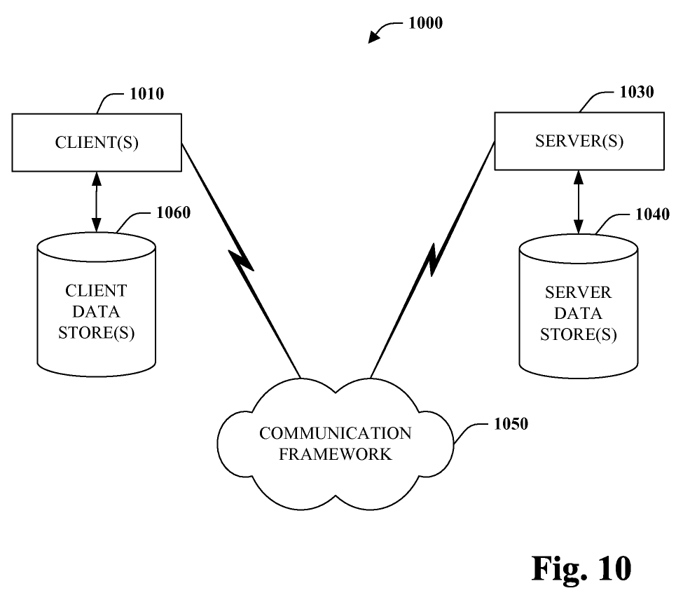

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 9, an exemplary environment 910 for implementing various aspects disclosed herein includes a computer 912 (e.g., desktop, laptop, server, hand held, programmable consumer or industrial electronics . . . ). The computer 912 includes a processing unit 914, a system memory 916, and a system bus 918. The system bus 918 couples system components including, but not limited to, the system memory 916 to the processing unit 914. The processing unit 914 can be any of various available microprocessors. It is to be appreciated that dual microprocessors, multi-core and other multiprocessor architectures can be employed as the processing unit 914.

The system memory 916 includes volatile and nonvolatile memory. The basic input/output system (BIOS), containing the basic routines to transfer information between elements within the computer 912, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 912 also includes removable/non-removable, volatile/non-volatile computer storage media. FIG. 9 illustrates, for example, mass storage 924. Mass storage 924 includes, but is not limited to, devices like a magnetic or optical disk drive, floppy disk drive, flash memory, or memory stick. In addition, mass storage 924 can include storage media separately or in combination with other storage media.

FIG. 9 provides software application(s) 928 that act as an intermediary between users and/or other computers and the basic computer resources described in suitable operating environment 910. Such software application(s) 928 include one or both of system and application software. System software can include an operating system, which can be stored on mass storage 924, that acts to control and allocate resources of the computer system 912. Application software takes advantage of the management of resources by system software through program modules and data stored on either or both of system memory 916 and mass storage 924.

The computer 912 also includes one or more interface components 926 that are communicatively coupled to the bus 918 and facilitate interaction with the computer 912. By way of example, the interface component 926 can be a port (e.g., serial, parallel, PCMCIA, USB, FireWire . . . ) or an interface card (e.g., sound, video, network . . . ) or the like. The interface component 926 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 912 to output device(s) via interface component 926. Output devices can include displays (e.g., CRT, LCD, plasma . . . ), speakers, printers and other computers, among other things.

FIG. 10 is a schematic block diagram of a sample-computing environment 1000 with which the subject innovation can interact. The system 1000 includes one or more client(s) 1010. The client(s) 1010 can be hardware and/or software (e.g., threads, processes, computing devices). The system 1000 also includes one or more server(s) 1030. Thus, system 1000 can correspond to a two-tier client server model or a multi-tier model (e.g., client, middle tier server, data server), amongst other models. The server(s) 1030 can also be hardware and/or software (e.g., threads, processes, computing devices). The servers 1030 can house threads to perform transformations by employing the aspects of the subject innovation, for example. One possible communication between a client 1010 and a server 1030 may be in the form of a data packet transmitted between two or more computer processes.

The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

Client/server interactions can be utilized with respect with respect to various aspects of the claimed subject matter. By way of example and not limitation, the parser generation system or a component thereof can be embodied as a network service resident on a server 1030 and accessible by one or more clients 1010 across communication framework 1050. Additionally or alternatively, extensibility points can invoke external code/logic afforded by one or more clients 1010 or service 1030 by over the communication framework 1050. For instance, a scanner can be provided as a service and employed as an extension to scan or tokenize all or portions of code.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

What is claimed is:

1. A parser generation system, comprising:
an interface component that receives a lexical specification; and
a generator component that produces an extensible parse map based on the specification, the map includes fixed data that identifies state transitions as a function of input and current state and one or more extension points to enable arbitrary code invocation.

2. The system of claim 1, the lexical specification identifies the one or more extension points that identify the arbitrary code.

3. The system of claim 2, the extension points includes one or more special delimiters and reference to the code.

4. The system of claim 2, the lexical specification includes variable definitions and employment of defined variables.

5. The system of claim 1, the arbitrary code corresponds to an alternate scanner.

6. The system of claim 1, the map is a table.

7. The system of claim 6, the table specifies the arbitrary code with a character in a reserved range.

8. The system of claim 6, the table references an index that identifies the arbitrary code.

9. The system of claim 1, the arbitrary code determines if a token should be allowed based on rules at the time of execution.

10. The system of claim 1, the map is a finite function.

11. The system of claim 1, further comprising a component that compresses the map.

12. A parser generation method, comprising:
acquiring a lexical specification including an extension point; and
generating a parse table that comprises a set of fixed data identifying state transitions based on current input and state and an extension point that specifies external code to facilitate identification of state.

13. The method of claim 12, producing code that employs the parse table to guide parsing of a programmatic language.

14. The method of claim 12, further comprising denoting the extension point with a character from a restricted range character set.

15. The method of claim 12, further comprising generating the external code.

16. The method of claim 15, further comprising referencing another parse table to facilitate parsing of an embedded language.

17. The method of claim 12, further comprising compressing the parse table into a compact and efficient representation.

18. A computer-readable medium having stored thereon a parse table, comprising:
a number of columns identifying input characters; and
a number of rows identifying parsing states, the intersection between the columns and rows identifies either a state transition or an extensibility point that calls out to arbitrary code, the parse table includes at least one extensibility point.

19. The computer-readable medium of claim 18, the extensibility point is encoded as a character from a reserved character range.

20. The computer-readable medium of claim 19, the character identifies particular code or an index from which the code can be located.
